(19) United States
(12) Patent Application Publication
(10) Pub. No.: US 2024/0343336 A1
(43) Pub. Date: Oct. 17, 2024

(54) Motorcycle

(71) Applicant: Zhejiang CFMOTO Power Co., Ltd., Hangzhou (CN)

(72) Inventors: Yulong Gan, Hangzhou (CN); Chengqun Ma, Hangzhou (CN); Jutao Yang, Hangzhou (CN); Jun Wang, Hangzhou (CN); Tongmin Xu, Hangzhou (CN); Genxin Bao, Hangzhou (CN); Dehuai YU, Hangzhou (CN); Xinxin Gan, Hangzhou (CN); Jun Zhang, Hangzhou (CN); Bingxiang LV, Hangzhou (CN)

(21) Appl. No.: 18/752,026

(22) Filed: Jun. 24, 2024

Related U.S. Application Data
(63) Continuation of application No. PCT/CN2022/136630, filed on Dec. 15, 2022.

(30) Foreign Application Priority Data
Dec. 29, 2021 (CN) 202111637229.2

(51) Int. Cl. B62K 11/04; B62J 50/26; B62K 25/28

(52) U.S. Cl. CPC B62K 11/04; B62J 50/26; B62K 25/283

(57) ABSTRACT

A motorcycle includes a power system and a frame. The preferred frame has a main frame, a sub-frame extending rearwardly from the back of the main frame, a middle frame extending downwardly from the back of the main frame, and a front frame extending forwardly from a front of the main frame. The frame is primarily formed from tubular frame components, but also includes at least one plate frame component, and at least one casting. For instance considering the main frame, the main frame includes a head tube, an upper main frame tube, and a lower main frame tube. A mounting plate connects the upper main frame tube and the lower main frame tube, and further positions and supports the power source. A casting defines an angle of the upper main frame tube relative to the lower main frame tube.

### RELATED APPLICATION INFORMATION

The present application is a continuation of PCT/CN2022/136630, filed Dec. 15, 2022, and claims the benefits of priority to Chinese Patent Application No. 202111637229.2, filed with the Chinese Patent Office on Dec. 29, 2021, both entitled “Motorcycle”. The entire contents of the above-referenced applications are incorporated herein by reference.

### FIELD OF THE DISCLOSURE

The present application relates to the field of vehicles, and particularly to a motorcycle.

### BACKGROUND OF THE DISCLOSURE

As a type of motorcycle frame, the trellis-type frame has a long span. The common split trellis-type frame has a risk of loosening between the main frame and sub-frame. The relative sizes of the main frame weldment and the sub-frame weldment are not guaranteed, and welding deformation is difficult to control, making it difficult to ensure the connection accuracy of the frame, which can increase frame manufacturing difficulties and decrease frame stability. At the same time, as the main load-bearing body of the motorcycle, many components or assemblies need to be mounted on the frame, and it is difficult to make the frame and attached mounting structures as light as possible. It is difficult to adequately fix assemblies (such as the engine and the rear suspension, for example) onto the frame while optimizing the frame size. In order to stably connect the desired components or assemblies, it has often been necessary to increase the overall size and weight of the frame, thereby limiting the performance of the motorcycle.

### SUMMARY OF THE INVENTION

The present invention is a motorcycle, which has enhanced frame connection strength while maintaining light weight.

In first aspect, a motorcycle includes a power system, a frame, a manipulation system, a seating structure, a set of wheels and a suspension. The power system includes a power source for locomotion of the motorcycle. The frame supports the power system. The manipulation system is supported by the frame. The seating structure is arranged above the frame. The suspension connects the set of wheels including at least one front wheel and at least one rear wheel to the frame. The frame includes a main frame which has a head tube, a plurality of frame tubes, a mounting plate and a casting. The plurality of frame tubes are connected to the head tube and extend rearwardly therefrom. The plurality of frame tubes include at least one upper main frame tube and at least one lower main frame tube. The mounting plate is connected between the upper main frame tube and the lower main frame tube. The mounting plate is adapted for positioning and supporting the power source. The casting is adapted for connecting the upper main frame tube and the lower main frame tube, thereby defining an angle of the upper main frame tube relative to the lower main frame tube.

In second aspect, the frame further includes a sub-frame positioned behind the main frame and secured to the main frame. The seating structure, which includes a seat cushion for a user to straddle and ride on, is supported by the sub-frame. The sub-frame has at least one right sub-frame tube on a right side of a longitudinal mid-plane of the motorcycle and at least one left sub-frame tube on a left side of the longitudinal mid-plane of the motorcycle. The sub-frame further has a license plate mount. The license plate mount extends across the longitudinal mid-pane of the motorcycle and is fixed to both the right sub-frame tube and the left sub-frame tube to strengthen the sub-frame.

In third aspect, the manipulation system includes a rear-view mirror having a reflective surface on a mirror support arm. The motorcycle further includes an electrical system support by the frame, and the electrical system includes a turn signal blinker. The turn signal blinker is supported on the mirror support arm. The reflective surface of the rear-view mirror can be pivoted relative to the mirror support arm without moving the turn signal blinker relative to the mirror support arm.

### BRIEF DESCRIPTION OF THE DRAWINGS

FIG. 1 is a rear left perspective view of a motorcycle according to a preferred embodiment of the invention;

FIG. 2 a left side view of the motorcycle of FIG. 1;

FIG. 3 is a left perspective view of a frame structure of the motorcycle of FIGS. 1 and 2;

FIG. 4 is a schematic left side view of a portion of the frame structure of FIG. 3 relative to an outline of a power source used in the motorcycle of FIGS. 1 and 2;

FIG. 5 is a left side perspective view, from below, showing how a rear suspension attaches to the frame structure of FIG. 3, not showing the front frame;

FIG. 6 is a rear left perspective view of the frame of FIG. 3, not showing the front frame but showing certain attachment bolts in exploded view;

FIG. 7 is a front left perspective view of a main crosstube and a middle frame of the frame structure of FIG. 3;

FIG. 8 is a rear left perspective view of the frame structure of FIG. 3;

FIG. 9 is a front perspective view of the main frame and middle frame of the frame structure of FIGS. 3 and 8, showing an attachment structure in exploded view;

FIG. 10 is a cross-sectional view of the frame structure and outline of a power source of FIG. 4, taken along cut-lines 10-10;

FIG. 11 is an enlarged view of section 11 of FIG. 10;

FIG. 12 is a front left perspective view of a front frame of the frame structure of FIGS. 3 and 8;

FIG. 13 is a top plan view of the frame structure of FIGS. 3 and 8 supporting various components and assemblies;

FIG. 14 is a front view of the rear-view mirrors of the motorcycle of FIG. 1;

FIG. 15 is a rear perspective view of the left rear-view mirror of FIG. 14;

FIG. 16 is a front perspective view of the mirror seat of FIG. 15;

FIG. 17 is a cross-sectional view of a mirror support arm and mirror seat of the left rear-view mirror of FIGS. 14 and 15, taken along cut line 17-17 of FIG. 15;

FIG. 18 is a cross-sectional view the left mirror and blinker of FIGS. 14 and 15, taken along cut line 18-18 of FIG. 15; The right mirror support arm, mirror and blinker are preferably mirror image structures to the left, symmetrical about the longitudinal mid-plane;

FIG. 19 is a perspective view of the left blinker of FIGS. 14 and 15;

FIG. 20 is a cross-sectional view of the left blinker of FIGS. 14, 15 and 19, taken along cut line 20-20 of FIG. 19;

FIG. 21 is right side view of front portions of the housing of the motorcycle of FIGS. 1 and 2;

FIG. 22 is a right side view of the motorcycle housing portions of FIG. 21 but omitting the front cover body and leading wing;

FIG. 23 is a front view of the housing portions shown in FIG. 21;

FIG. 24 is a front perspective view (slightly upwards and inside out) of the housing portions shown in FIG. 23, but omitting the front cover body;

FIG. 25 is left rear perspective view showing several components including the fuel tank and front suspension of the motorcycle in FIGS. 1 and 2 attached to the frame of FIGS. 3 and 8;

FIG. 26 is a left front perspective view of the fuel tank of FIGS. 1, 2 and 25;

FIG. 27 is a cross-sectional view through a portion of the front wheel and front suspension of the motorcycle of FIGS. 1 and 2, taken along the centerline of the front shock absorbers and front wheel axis;

FIG. 28 is a right side view of the rear sprocket and rear wheel hub of the motorcycle of FIGS. 1 and 2;

FIG. 29 is a front perspective view of the main seat cushion of the motorcycle of FIGS. 1 and 2;

FIG. 30 is a front perspective view of the sub-frame and housing portions which support the main seat cushion of FIG. 29;

FIG. 31 is a side perspective view of some of the sub-frame and housing portions of FIG. 30, and further showing the preferred seat lock cable;

FIG. 32 is a top perspective view of the housing portion of FIG. 30, and further showing where the power supply of the electrical system is preferably mounted;

FIG. 33 is a rear cross-sectional view of the power supply mount, power supply and voltage regulating rectifier of FIG. 32, taken along cut lines 33-33 in FIG. 32;

FIG. 34 is a cross-sectional front view showing the mounting of the main seat cushion of FIGS. 1, 2 and 29, taken along cut line 34-34 of FIG. 2;

FIG. 35 is a bottom view looking up at the fuel tank and seating structure in the motorcycle of FIGS. 1 and 2;

FIG. 36 is a top plan view of certain front portions of the housing of the motorcycle of FIGS. 1 and 2 including the left housing flap;

FIG. 37 is a bottom plan view of the left housing flap of FIG. 36;

FIG. 38 is a perspective view in partial cross-section showing attachment of a universal serial bus interface to a portion of the housing of the motorcycle in FIGS. 1 and 2 using an elastic sleeve;

FIG. 39 is a perspective view of two side housing portions of the motorcycle of FIGS. 1 and 2 held together by a clip; and

FIG. 40 is a close up view of portion 40 of FIG. 39 better showing the housing attachment clip.

The accompanying drawings herein are incorporated into the specification and form a part of this specification, illustrating embodiments in accordance with the present application and used together with the specification to explain the principles of the present application.

### DETAILED DESCRIPTION

For a better understanding of the purpose, technical solutions and advantages of the present invention, preferred embodiments of the present invention are described and illustrated below.

The embodiments described herein are only used to explain this invention and are not intended to limit. Numerous other minor modifications, embodiments and/or improvements can be devised by those skilled in the art which fall within the scope and spirit of the principles of this invention.

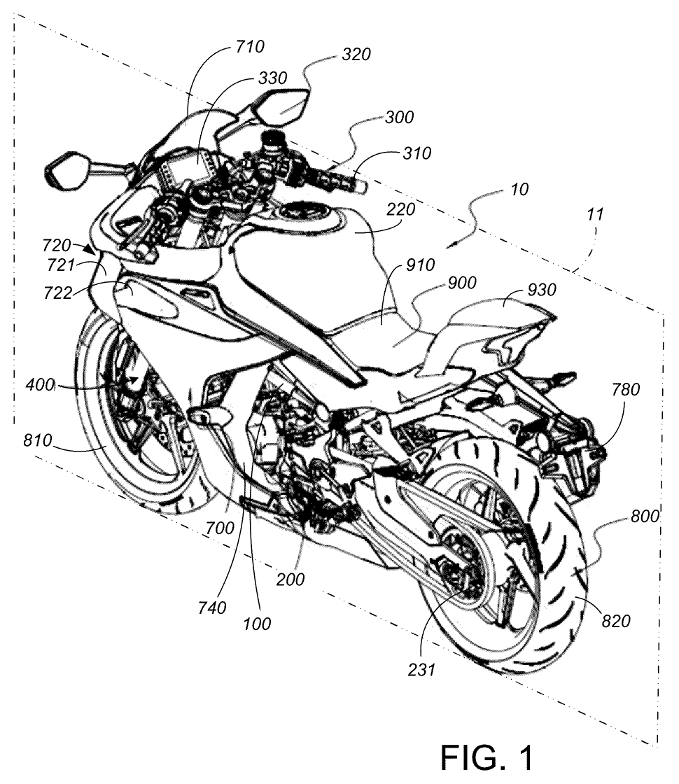

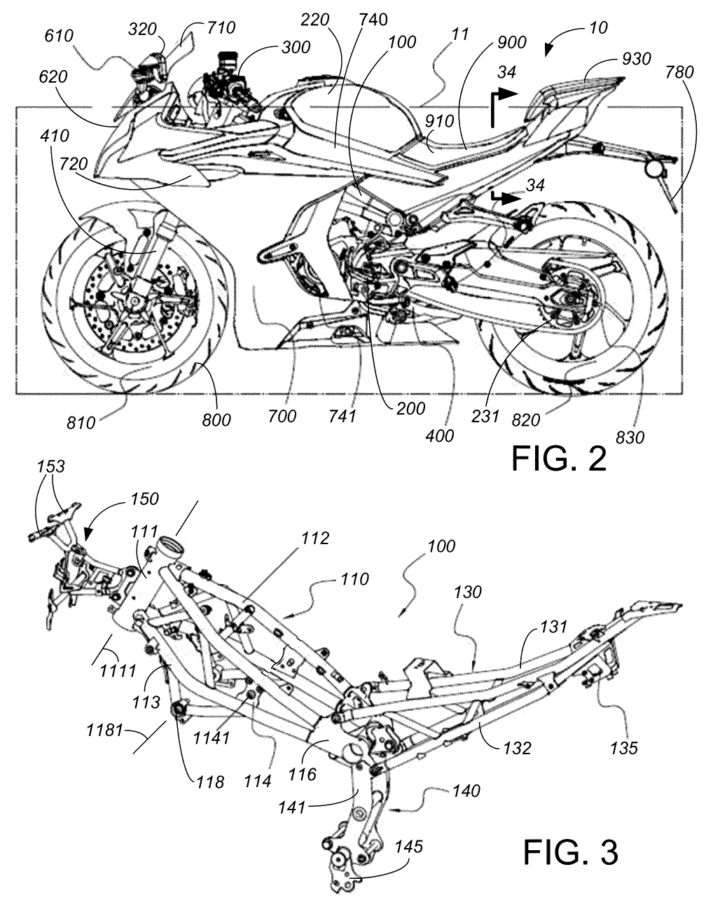

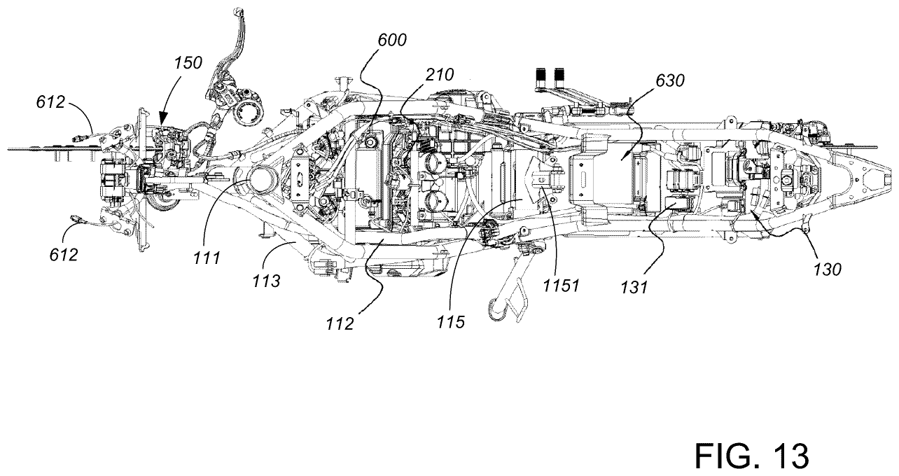

Referring primarily to FIGS. 1 and 2 and secondarily to FIG. 13, a motorcycle 10 includes a frame 100, a power system 200, a manipulation system 300, a suspension 400, an electrical system 600 (shown in part and called out only in FIG. 13), a housing 700, a set of wheels 800, and a seating structure 900. The set of wheels 800 includes at least one front wheel 810 and at least one rear wheel 820. The power system 200 includes a power source 210 for powering at least one wheel 810, 820 through a transmission 230 for locomotion of the motorcycle 10. The power system 200 and the manipulation system 300 are supported by the frame 100. The manipulation system 300 is used for the driver to control the running of the motorcycle 10. The suspension 400 connects the set of wheels 800 to the frame 100. The electrical system 600 provides electricity and/or electrical signal paths to or between various components of the motorcycle 10. The housing 700 covers at least a portion of the frame 100. The seating structure 900 includes a main seat cushion 910 arranged above the frame 100 for a driver to ride on, as well as an upper cushion 930. A passenger can optionally sit on the upper cushion 930 to ride behind the driver.

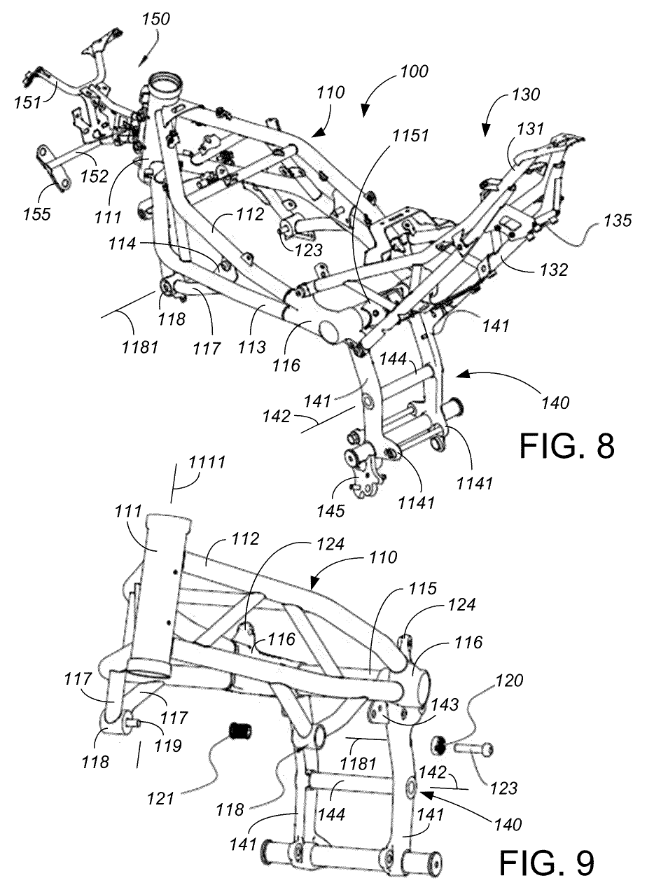

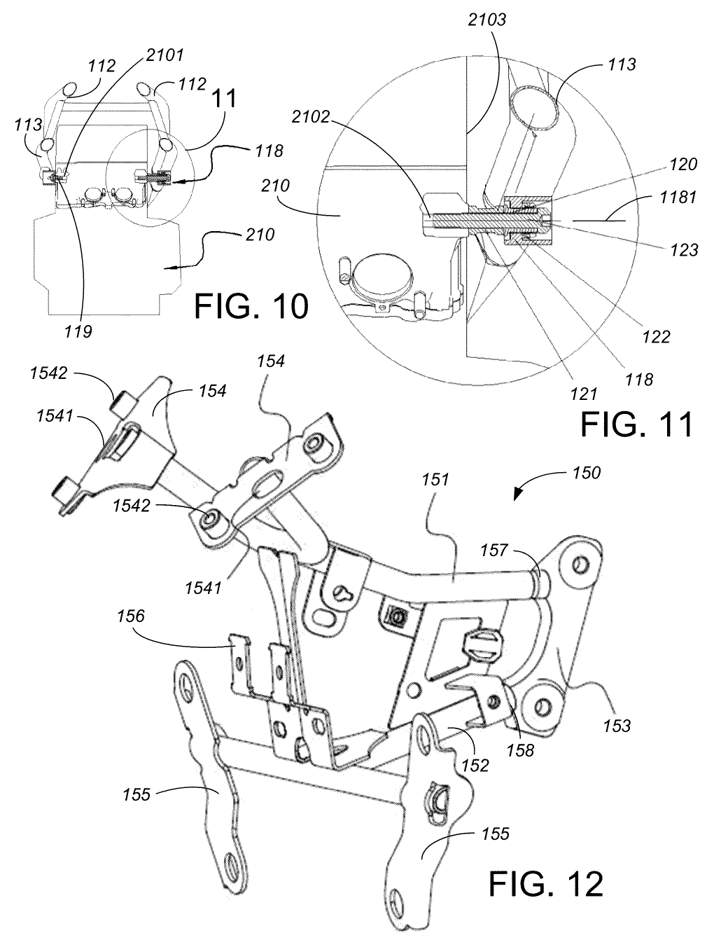

FIGS. 3 to 12 better show the frame 100, with FIGS. 3 and 8 showing the entirety of the frame 100. The frame 100 generally includes a main frame 110 as a backbone of the motorcycle 10, a sub-frame 130 extending rearwardly from the back of the main frame 110, a middle frame 140 extending downwardly from the back of the main frame 110, and a front frame 150 extending forwardly from the front of the main frame 110. The frame 100 is generally formed from tubular components which are arranged substantially symmetrically relative to a longitudinal mid-plane 11, and various plates or brackets which are attached to the tubular components which may or may not be symmetrical relative to the longitudinal mid-plane 11. The strength of tube bodies is high, which improves the stability of the frame 100. However, tube bodies are relatively heavier than plates and brackets, and the excessive use of tube bodies in the frame 100 makes the frame 100 heavier, thereby adversely affecting the performance of the motorcycle 10. Therefore, some non-tubular components are used to connect between the tube bodies to enhance the stability and strength of the frame 100, and effectively reduce the overall weight of the frame 100. In addition, the curved exterior surface of tube bodies is not convenient for mounting components of the power system 200, the manipulation system 300, the suspension 400, the electrical system 600, the housing 700 and/or the seating structure 900, and non-tubular components such as plates and brackets better provide planar mounting surfaces.

The main frame 110 includes a head tube or steering head 111 which receives upward force from a front suspension 410 and defines the steering pivot axis 1111 of the motorcycle 10. The preferred main frame 110 has a pair of upper frame tubes 112 extending rearwardly and somewhat downwardly from the head tube 111 on left and right sides of the longitudinal mid-plane 11, and a pair of lower frame tubes 113 extending rearwardly and slightly downwardly from the head tube 111 on left and right sides of the longitudinal mid-plane 11.

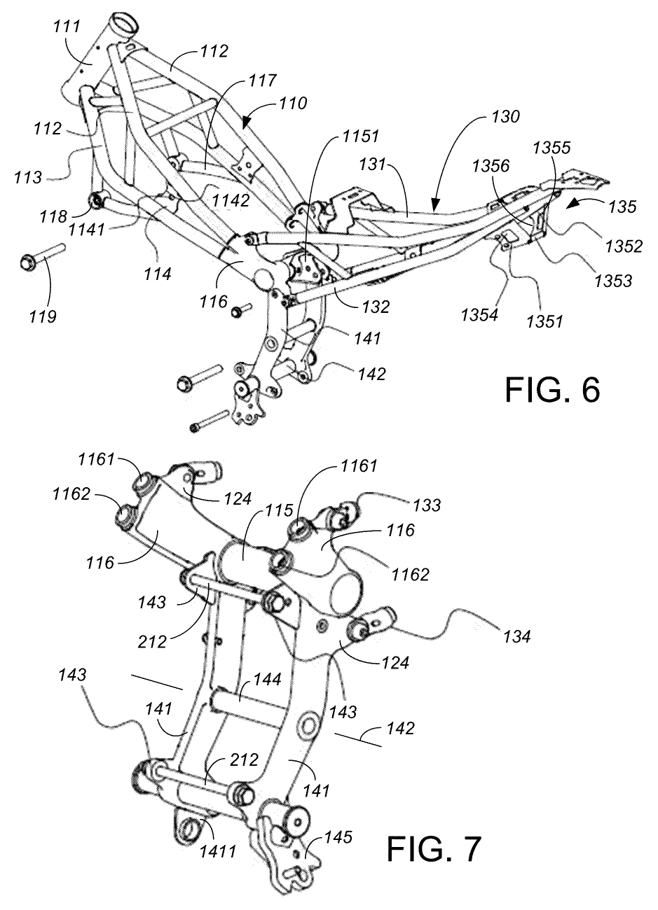

Right and left mounting plates 114 are attached as part of the main frame 110, preferably by welding, between the respective upper frame tubes 112 and lower frame tubes 113. The main frame mounting plates 114 are used for mounting or supporting the power system 200, the manipulation system 300, the seating structure 900, or any combination or components thereof. For instance, in the preferred embodiment the main frame mounting plates 114 each include a through hole 1141 used for mounting the power source 210 such as by using two power source mounting bolts 211, one of which is shown in FIG. 6. The main frame mounting plates 114 thus help eliminate the need for welded attachments between the tube bodies and components of the power system 200, the manipulation system 300, and/or the seating structure 900, thereby simplifying the structure of the frame 100 and reducing its weight. The overall span of the main frame 110 is large, and the welded structure is prone to deformation. Connecting the main frame mounting plates 114 between the upper and lower frame tubes 112, 113 can strengthen the overall strength of the main frame weldment 110 and reduce flexibility and/or deformation over long-term use of the motorcycle 10. The main frame mounting plates 114 are relatively light in weight and use less steel compared to making a similarly located connection between the upper and lower frame tubes 112, 113 via tubing, which saves costs and further reduces the weight of the main frame 110. For instance, the main frame mounting plates 114 can be stamped and bent out of steel sheet material having a thickness not greater than 5 mm, and more preferably having a thickness of 3 mm or less.

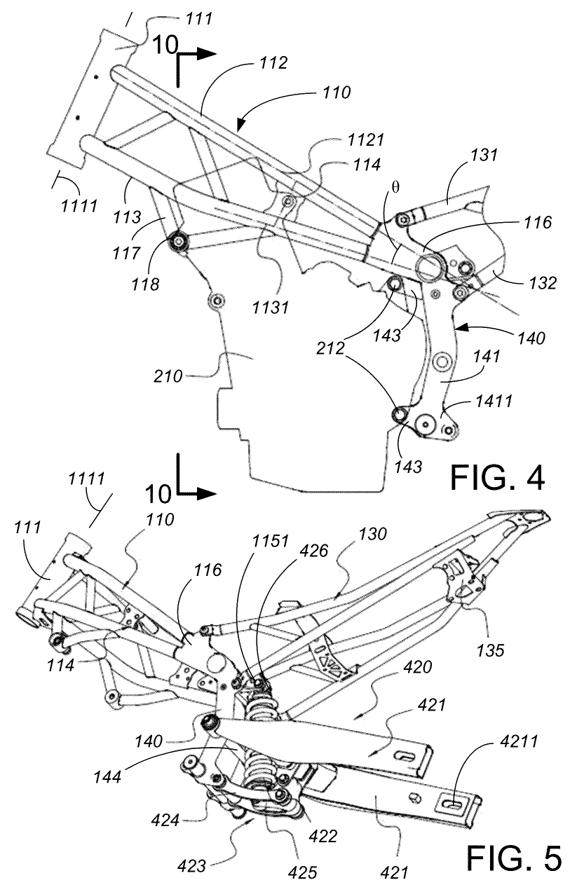

A main crosstube 115 is attached at rear ends of the upper and lower frame tubes 112, 113. The main crosstube 115 extends horizontally and transversely across the longitudinal mid-plane 11, and receives upward force from a rear suspension 420. Upper positioning rings 1161 and lower positioning rings 1162 are preferably included on right and left ends of the main crosstube 115 so the upper and lower frame tubes 112, 113 can be easily welded so as to be fixed relative to the main crosstube 115. While inside diameters of positioning rings could alternatively be larger than the outer diameters of the upper and lower frame tubes 112, 113 and welded on the outside of the upper and lower frame tubes 112, 113, the preferred positioning rings 1161, 1162 have outer diameters which are slightly smaller than the respective inner diameters of the upper and lower frame tubes 112, 113 with the upper and lower frame tubes 112, 113 welded around the respective positioning rings 1161, 1162. On each side, the structure for the upper positioning ring 1161 is integrally formed with the structure for the lower positioning ring 1162 such as by being formed by a casting 116, so that the positions of the upper and lower frame tubes 112, 113 on each side of the vehicle 10 are fixed with axes 1121, 1131 forming a V-shape with a main frame tube angle θ as shown in FIG. 4. Left and right castings 116 are preferably joined to the main cross tube 115 by welding. Proper formation of the upper and lower positioning rings 1161, 1162 via an integral structure such as casting 116 reduces assembly size deviation, improving the overall stability of the frame 100. Alternatively the upper and lower frame tubes 112, 113 could be attached relative to the main crosstube 115 by a press fit connection, by a threaded connection or by bolts.

The main frame 110 includes left and right support tubes 117 which extend below the respective lower frame tube 113 and support left and right fixation sleeves 118. The fixation sleeves 118 define a generally horizontal and transversely oriented front mount axis 1181 (as called out in FIGS. 3, 8 and 11) for the power source 210. The preferred arrangement for connecting the power source 210 to the fixation sleeves 118 is further shown in FIGS. 9-11. A bolt 119 is preferably used through one of the fixation sleeves 118 (in the preferred embodiment, the right fixation sleeve 118) and in threaded engagement with a hole 2101 in the power source 210 to set the desired right-to-left position of the power source 210. Alternatively, the bolt 119 can be replaced with an unthreaded pin welded or otherwise fixed to its respective fixation sleeve 118. At least one of the fixation sleeves 118 (in the preferred embodiment the left fixation sleeve 118) is internally threaded to threadingly receive a screw barrel insert 120. The screw barrel insert 120 is both internally and externally threaded. The depth (axial position) of the screw barrel insert 120 relative to the fixation sleeve 118 can be changed by rotating the screw barrel insert 120. Once the screw barrel insert 120 is rotationally advanced to its desired depth (axial position) relative to its fixation sleeve 118 so a spacer 121 fits in the gap between the screw barrel insert 120 and a face 2103 of the power source 210, the screw barrel insert 120 is fixed in place by tightening rotation of a lock nut 122. The spacer 121 abuts the power source 210 on its inside end and abuts the screw barrel insert 120 on its outside end. A mounting bolt pin 123 extends through the screw barrel insert 120 in threaded engagement, and also extends through the spacer 121 and into a mounting hole (through hole or recess) 2102 on the power source 210 without threaded engagement. The mounting bolt pin 123 has threads along its shaft which terminate prior to the distal end advanced into the mounting hole 2102. The mounting bolt pin 123 is rotationally advanced until tight against the screw barrel insert 120. Rotational advancement of the screw barrel insert 120 thus adjusts the connection distance, eliminating any deformation of the main frame 110 to compensate for the distance between the main frame 110 and the power source 210 and also eliminating any transfer of stress through the power source 210, thereby simplifying the assembly process and enhancing the strength of the frame 100.

The spacer 121 extends the length of the connection distance and allows more lateral play while positioning the power source 210 relative to the main frame 110. Alternatively, a spacer could be provided as an integral part of a screw barrel insert. While the preferred embodiment uses a single screw barrel insert 120, spacer 121, lock nut 122 and mounting bolt pin 123 on only one side (the left side) of the power source 210, an alternative embodiment uses screw barrel inserts, spacers, lock nuts and mounting bolt pins on both left and right sides of the power source 210.

The sub-frame 130 includes a pair of upper sub-frame tubes 131 and a pair of lower sub-frame tubes 132 both extending longitudinally and somewhat upwardly and connected at their front ends to the main frame 110. For instance, the main crosstube 115 preferably has sub-frame attachment ears 124 (called out in FIG. 7), and sub-frame tube ends 133, 134 are formed that are first welded into the respective upper and lower sub-frame tubes 131, 132 and then used to bolt the sub-frame weldment 130 to the main crosstube 115.

The sub-frame 130 includes a license plate mount 135 connected to the sub-frame tubes 131, 132 so as to extend across the longitudinal mid-plane 11. The license plate mount 135 is used for connecting a license plate bracket 780 (shown only in FIGS. 1 and 2), which is used for mounting the license plate (not shown). The overall span of the sub-frame 130 is large, and the sub-frame weldment 130 is prone to deformation. Connecting the license plate mount 135 to the right and left sub-frame tubes 131 and/or 132 can strengthen the overall strength of the sub-frame 130 and reduce flexibility and/or deformation over long-term use of the motorcycle 10.

As called out in FIG. 6, the preferred license plate mount 135 includes a left portion 1351 and a right portion 1352 each angling downwardly and inwardly, and a transverse central portion 1353 connecting the left and right portions 1351, 1352, such that the license plate mount 135 is symmetrical about the longitudinal mid-plane 11. The right and left portions 1351, 1352 define lightening holes 1354 in their middles, thereby making the license plate mount 135 lighter. One or a plurality of reinforcement ribs 1355 are arranged on the side edges of the license plate mount 135. At least one side end of the license plate mount 135 is provided with a stress dispersion area 1356 concave towards its inner side to prevent damage to the structure of the license plate mount 135 due to stress concentration. The license plate mount 135 can be stamped and bent out of steel sheet material having a thickness not greater than 5 mm, and more preferably having a thickness of 3 mm or less. If desired, similar reinforcement ribs and stress dispersion areas can be added to the main frame mounting plates 114, such as stress dispersion area 1142 called out in FIG. 6.

The middle frame 140 has left and right legs 141 which extend downwardly from the back of the main frame 110. The legs 141 and define a pivot axis 142 for left and right rocker arms 421 of the rear suspension 420 shown in FIG. 5. The middle frame 140 also preferably includes four connection ears 143 for connecting the power source 210 using two power source mounting crossbolts 212. In the preferred embodiment, the middle frame 140 is integrally formed with the main crosstube 115, such that the power source connection ears 143 are integrally formed with the upper and lower positioning rings 1161, 1162. For instance, the middle frame 140 and the main crosstube 115 can be jointly formed by casting, saving a lot of welding steps, eliminating many welding members, and reducing the overall weight of the frame 100. The preferred embodiment welds the main crosstube 115 and the legs 141 of the middle frame 140 to the castings 116 to form a strong integrated structure. Integrally forming the middle frame 140 with the main crosstube 115 can reduce the assembly errors of the main frame 110, the power source 210, and the middle frame 140, reduce assembly difficulty, simplify production process, and make the overall structure of the frame 100 more stable, thereby firmly fixing the power source 210. Alternatively, the legs 141 of the middle frame 140 could be attached to the main crosstube 115 such as by bolts or welding.

As best shown in FIG. 4, the heights of the power source mounting crossbolts 212 are lower than the height of the fixation sleeves 118 and lower than the height of the power source mounting plates 114. The four mounting positions defined by the fixation sleeves 118, the mounting plates 114 and the two power source mounting crossbolts 212 are arranged in an arch shape, so that the middle frame 140 and the main frame 110 support the power source 210 in a semi-enclosure form.

The preferred rear suspension 420 is better shown in FIG. 5. The rear suspension 420 includes left and right rear rocker arms 421 pivotally connected at their leading ends to the middle frame 140, preferably to the outer sides of the legs 141 of the middle frame 140. For instance, the preferred middle frame 140 includes an intermediate tube 144 extending transversely across the longitudinal mid-plane 11 which defines the rear suspension pivot axis 142 (called out in FIG. 7). The intermediate tube 144 is preferably welded to each of the legs 141 of the middle frame 140, providing not only structure for pivotally connecting the rear rocker arms 421 but also improving the assembly accuracy and enhancing the strength of the middle frame 140. Trailing ends of the rocker arms 421 are adapted for connection to the rear wheel 820, such as by each having an opening 4211 for a stub axle of the rear wheel 820.

Suspension motion of the rear rocker arms 421 is dampened by a rear shock absorber 422, which is positioned at the longitudinal mid-plane 11 and extends substantially vertically between the rocker arms 421. At its upper end, the rear shock absorber 422 connects to an upper shock absorber mount 1151 on the main crosstube 115. The upper shock absorber mount 1151 includes a pre-load adjustment portion 426 for adjusting the rear shock absorber 422. The pre-load adjustment portion 426 is located below a sub-frame bottom housing plate 770 (shown in FIGS. 30-32) of the housing 700, so that the user can directly operate the pre-load adjustment 426 in the horizontal direction without dismantling any portions of the frame 100 or the housing 700, thereby improving convenience. The upper shock absorber mount 1151 allows detachable connection of the rear shock absorber 422, for example, by means of threaded fasteners, which allows the user to directly remove the shock absorber 422 and take out the rear shock absorber 422 through a hole 771 in the sub-frame bottom housing plate 770, thereby making it convenient for later maintenance of the rear shock absorber 422.

While the lower end of the rear shock absorber 422 could alternatively be at the elevation of the rear rocker arms 421, the preferred embodiment includes a linkage 423 transferring force from rear rocker arms 421 to the lower end of the rear shock absorber 422, with the linkage 423 positioning the lower end of the rear shock absorber 422 below the elevation of the rear rocker arms 421 and therefore allowing the rear shock absorber 422 to better fit in the layout. The shock absorber linkage 423 is pivotally connected on its upper end to the rear rocker arms 421 to travel upwardly and downwardly with pivoting of the rear rocker arms 421, and pivotally connected toward the lower end of the shock absorber linkage 423 to the middle frame 140. For instance, the preferred legs 141 of the middle frame 140 include ears 1411 for attaching the shock absorber linkage 423. The middle frame 140, the shock absorber linkage 423 and the rear rocker arms 421 surround the shock absorber 422 in a semi-enclosure form. The structure of the rear suspension 420 is compact, which better utilizes the space between the middle frame 140 and the rear wheel 820.

The preferred shock absorber linkage 423 includes right and left substantially horizontal links 424 which sandwich a central substantially vertical link 425. The horizontal links 424 are pivotally connected at their leading ends to the middle frame 140, and pivotally connected at their trailing ends to the vertical link 425. The vertical link 425 is pivotally connected at its upper end to a middle location of the rear rocker arms 421, pivotally connected at its lower end to the trailing ends of the horizontal links 424, and pivotally connected at its front end to the lower end of the rear shock absorber 422. The rear suspension 420 thus creates a four-bar linkage structure consisting of the middle frame 140 as a first bar, the rear rocker arms 421 as a second bar, the vertical link 425 as a third bar and the horizontal links 424 as a fourth bar. The lower end of the shock absorber 422 and the front end of the vertical link 425 are capable of swinging vertically between the right and left horizontal links 424 for the rear suspension motion. The size and weight of the linkage 423 is small while increasing the travel length/damping stroke of the rear shock absorber 422 for its compact position in the layout, thereby improving the buffering capacity of the rear suspension 420 under different impact forces on the rear wheel 820 and making travel of the motorcycle 10 smoother.

The middle frame 140 preferably includes at least two connection plates 145 on the left and right sides. The connection plates 145 are used to connect other components to the middle frame 140.

The frame 100 further includes a front frame 150 best shown in FIGS. 3 and 12. The front frame 150 connects to and supports components forward of the handlebars 310. For instance, the front frame 150 is used for mounting of rear-view mirrors 320 and a display 330 of the manipulation system 300 as shown in FIG. 1, as well as for mounting front blinker (turn signal) lights 610 and a headlight 620 as shown in FIG. 2. The preferred front frame 150 includes an upper T-tube 151 and a lower T-tube 152 both extending from a head tube mount 153. Ends of the upper T-tube 151 terminate in left and right rear-view mirror mounting plates 154. Ends of the lower T-tube 152 terminate in left and right front housing mounting plates 155. A central mounting bracket 156 is provided vertically connecting the upper T-tube 151 and the lower T-tube 152 so they support each other, and the central mounting bracket 156 can be used for mounting the headlight 620 and other components such as the front windshield 710. The rear-view mirror mounting plates 154, the front housing mounting plates 155 and the central mounting bracket 156 are all preferably stamped from steel sheet material with their respective tube connections being welded. The rear-view mirror mounting plates 154 preferably each include an opening 1541 therethrough for access to the interior of the left and right upper T-tubes 151, which can be used for running wiring such as a blinker cable 612.

The head tube mount 153 provides T-tube positioning rings 157, 158, preferably with outer diameters which are slightly smaller that the inner diameters of the upper and lower T-tubes 151, 152, with the upper and lower T-tubes 151, 152 welded around the respective T-tube positioning rings 157, 158. The structure for the upper T-tube positioning ring 157 is integrally formed with the structure for the lower T-tube positioning ring 158, such as by forming the head tube mount 153 as a casting. Forming the head tube mount 153 as a casting can reduce welding points, simplify assembly process, prevent front frame deformation, and improve front frame strength.

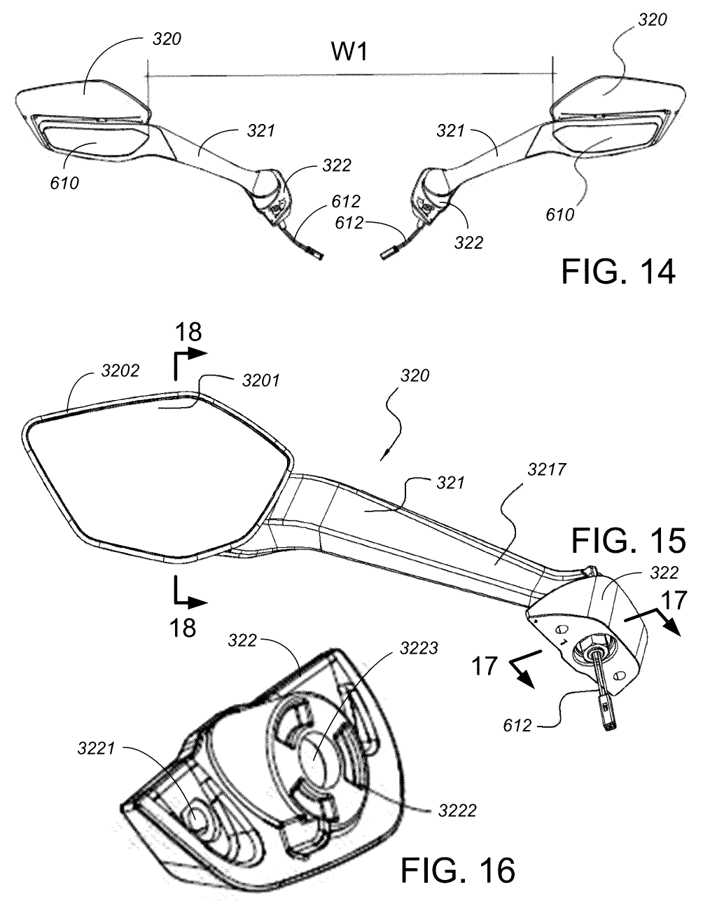

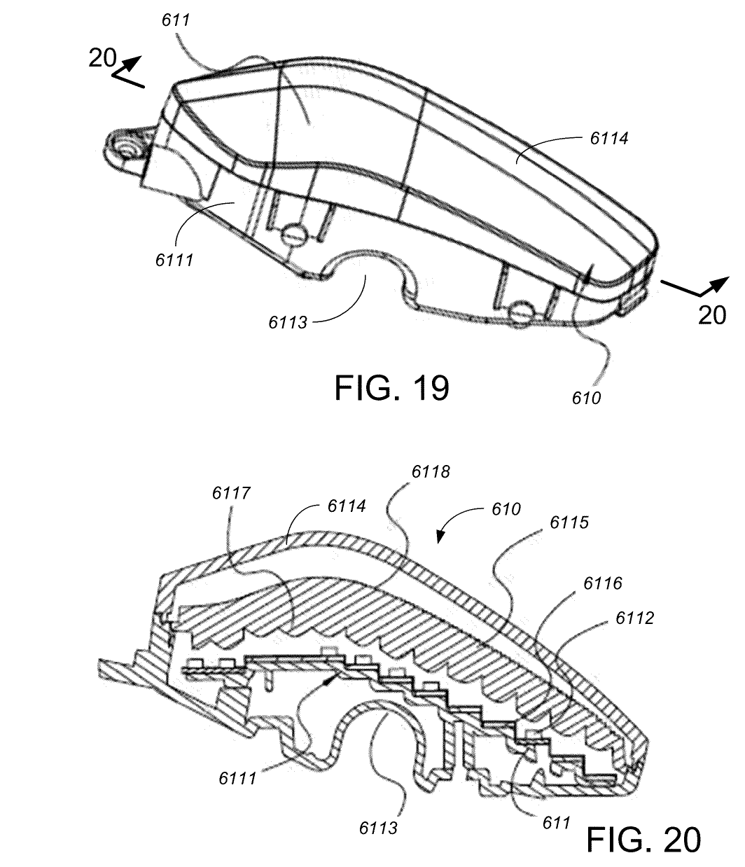

FIGS. 14-20 detail the preferred rear-view mirrors 320 and front blinkers 610 for the motorcycle 10. The front blinkers 610 are connected and exposed on front sides of the rear-view mirrors 320, and left and right mirror support arms 321 are used to support both the left and right rear-view mirrors 320 and the left and right front blinkers 610 from the rear-view mirror mounting plates 154 (shown in FIGS. 3 and 12).

Each of the front blinkers 610 includes a lighting portion 611 and a cable 612 electrically connected to the lighting portion 611 to control the lighting portion 611 to light up. By arranging the front blinkers 610 on the front sides of the rear-view mirrors 320, the blinkers 610 are held at relatively wide locations on the motorcycle 10 and there is no need to arrange additional rods to support turn signal lamps. The width distance W1 between the left and right blinkers 610, defined as the distance between the light emitting surfaces of the two lighting portions 611 closest to the longitudinal mid-plane 11, is preferably in the range from 420 mm to 500 mm, more preferably in the range from 450 mm to 490 mm, and most preferably in the range from 460 mm to 480 mm.

Each mirror support arm 321 extends from a mirror support seat 322 which is fixed to the respective rear-view mirror mounting plate 154. For instance, the preferred mirror support seat 322 includes through holes 3221 positioned to align with holes 1542 in the rear-view mirror mounting plate 154 via a screw or bolt connection.

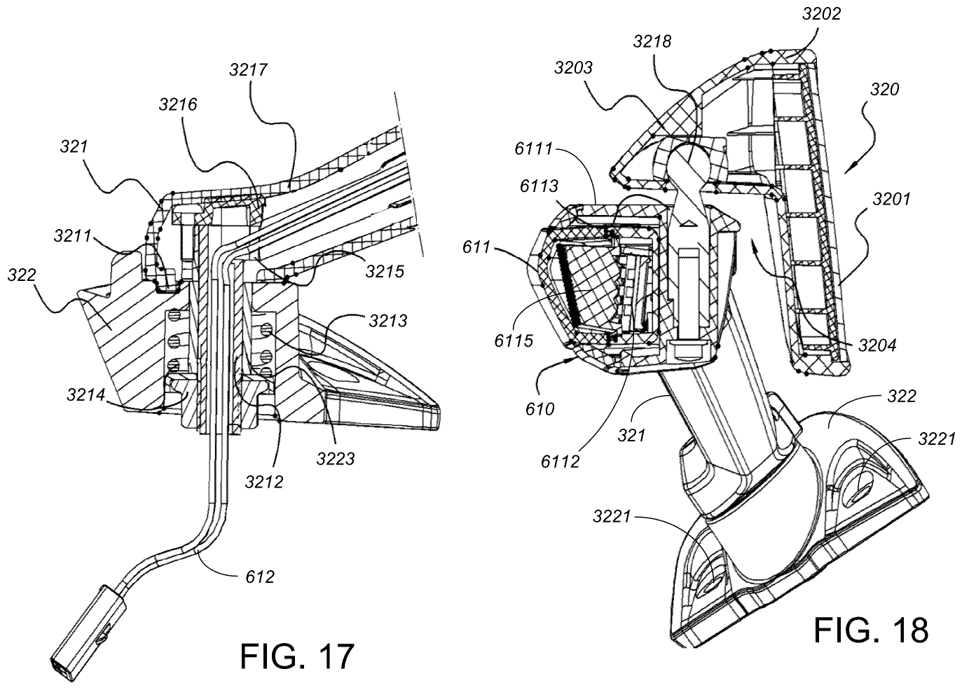

The connection between the mirror support arm 321 and the mirror support seat 322 allows the mirror support arm 321 to pivot relative to the mirror support seat 322, allowing the mirrors 320 to be hand moved such as between an upper usage position away from the housing 700 and a lower parking position close to the housing 700. For instance, the preferred mirror support seat 322 includes a series of three positioning recesses 3222 circumferentially spaced or staggered around a central seat through hole 3223 as shown in FIG. 16. As shown in FIG. 17, the mirror support arm 321 includes a corresponding series of positioning projections 3211 circumferentially spaced or staggered around an externally threaded stub 3212. When aligned, each of the positioning projections 3211 can be received in any of the positioning recesses 3222 in a mating relationship. During assembly, the stub 3212 is positioned through the central seat hole 3223 and held with a biasing member or spring 3213 and a nut 3214. Sides of the positioning recesses 3222 and positioning projections 3211 are inclined, and a hand force pushing the mirror 320 can compress the spring 3213 to allow the positioning projections 3211 to be retracted out of their positioning recesses 3222 while the mirror support arm 321 is hand pivoted, until after 120° of rotation the force of the spring 3213 causes the positioning projections 3211 to snap into the positioning recesses 3222 at the different (1200 offset) circumferential orientation. While the preferred embodiment uses three recesses 3222 and three corresponding projections 3211 to have mirror rest positions spaced at 120°, other embodiments can use different numbers of recesses/projections and different rest position spacing. The preferred connection between the mirror support arm 321 and the mirror support seat 322 thus allows multiple rest positions of the mirror 320, while still avoiding relative shaking caused by vibration during the running of the motorcycle 10, thereby making each of the rear view mirrors 320 stable as a whole.

The cable 612 runs centrally down the mirror support arm 321 to the lighting portion 611. Mounting the cable 612 in an interior channel of the mirror support arm 321 can enhance the aesthetics of the motorcycle 10 and extend the lifespan of the cable 612. Because the user can repeatedly pivot the mirror support arm 321 120° between driving and parking positions over time, there is a possibility of the cable 612 becoming entangled over time. The preferred mirror support arm 321 is specially constructed to minimize the possibility of such cable entangling. Namely, the mirror support arm 321 includes an inner tube 3215 that is initially molded prior to insertion of the cable 612 and attachment of a top cover 3216, and an outer covering 3217 that is formed around the inner tube 3215 and top cover 3216 in a secondary injection molding process. The inner tube 3215 and the top cover 3216 can effectively prevent polymer material from being injected into contact with the cable 612 during the secondary injection molding process, which could otherwise affect performance of cable 612 and promote entangling. The molded inner tube 3215 has sufficient clearance around the cable 612 to prevent the cable 612 located inside the mirror support arm 321 from being excessively pulled when the mirror support arm 321 rotates relative to the mirror support seat 322, thereby improving the service life of cable 612. Meanwhile, the secondary molding process can make the outer covering 3217 smoother, and the cable 612 is isolated from high temperature, precipitation and wind by the outer covering 3217 and the inner tube 3215.

The distal end of the mirror support arm 321 is used for mounting both the blinker light 611 and a reflective surface 3201 of the rear view mirror 320 as best shown in FIG. 18. A ball pin rod 3218 is secured within the distal end of the mirror support arm 321 as part of the secondary molding process. Alternatively, the ball pin rod 3218 may be secured between the blinker housing 6111 and the mirror support arm 321 when the blinker 610 is attached during assembly to the mirror support arm 321. The rear view mirror 320 includes a reflective surface component 3201 within a mirror housing 3202. The side of the mirror housing 3202 away from the reflective surface 3201 includes a ball connection portion 3203, which mates around the spherical end of the ball pin rod 3218. The connection between the ball connection portion 3202 and the ball end of the ball pin rod 3218 allows the mirror housing 3202 to be hand moved relative to the ball pin rod 3218 and the mirror support arm 321, pivoting about the center point of the spherical end of the ball pin rod 3218. A preset gap 3204 is defined between the mirror housing 3202 and the distal end of the mirror support arm 321, thereby allowing for relative movement of the reflective surface 3201 of the rear-view mirror 320. The relative movement should allow the reflective surface 3201 to be pivoted at least 200 relative to the mirror support arm 321, and the preferred embodiment allows the reflective surface 3201 of the rear-view mirror 320 to be pivoted up to 60° relative to the mirror support arm 321. The rear-view mirror 320 can thus be hand pivoted relative to the mirror support arm 321 and frictionally maintain any of a multitude of user-selected positions, so as to compensate for user height and desired viewing angle.

Construction of the blinker 610 is best shown with reference to FIGS. 18-20. The blinker light 611 preferably includes a plurality of LEDs 6112 which emit light responsive to the electrical signal and power provided on the cable 612. The light emission direction of each blinker light 611 is forward, substantially opposite to the direction of the reflective mirror surface 3201 of the rear-view mirror 320 (subject to hand positioning of the angle of the rear-view mirror 320). The LEDs 6112 are housed within a blinker housing 6111, which in turn defines a ball pin rod recess 6113. Having the blinker housing 6111 separate from the mirror housing 3202 allows mirror pivoting without changing the direction of light emission from the blinker 610. If the blinker housing were alternatively integrated into the mirror housing, then the light emission direction would change when the user tilts the mirror, making it potentially difficult for the brightness and illumination of the turn signal to be adequately seen by other drivers.

The plurality of LEDs 6112 are mounted behind a transparent or translucent weatherproof cover 6114, behind a light guiding element 6115 and in front of a reflective surface 6116. The light guiding element 6115 is used for focusing light and improving the uniformity of the light, thereby improving the performance of the blinker 610. The light guiding element 6115 includes a plurality of light-focusing portions 6117 and a plurality of light-diverging portions 6118 on opposing sides of its body. The light guiding element 6115 is transparent or translucent. The light-focusing portions 6117 each have a hyperbolic concave surface positioned towards the associated LED 6112 to refract light emitted from the LED 6112 in various directions into parallel light waves in the desired direction of light emission. The light-diverging portions 6118 each have a convex shape, which can diffuse the light and jointly create uniform projection of light from the plurality of individual LEDs 6112. The uniformity and brightness of the light emission of the front blinkers 610 is thus improved by integrating the secondary optics of the light guiding element 6115, so that smaller and/or fewer LEDs 6112 still provide sufficient brightness, and optimizing the size of the blinker light 611. The LEDs 6112 are preferably mounted at different planes relative to the direction of light emissions, so the blinker 610 can have the desired overall shape on the front of the mirror 320.

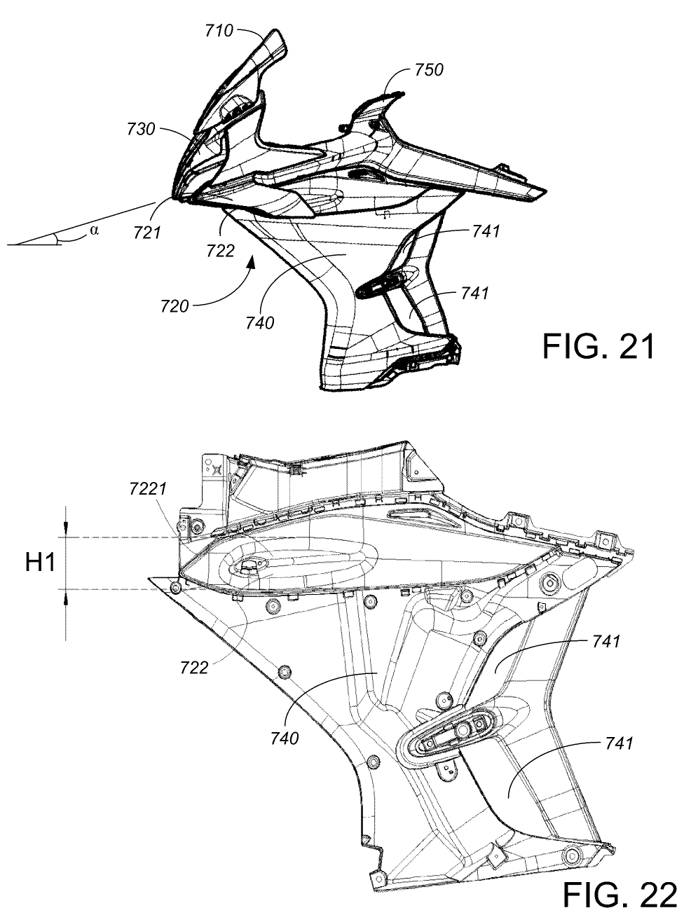

As shown in FIGS. 1 and 2, the housing 700 of the motorcycle 10 include left and right wing structures 720, attached at sides of the motorcycle 10 in front of the driver, preferably at a location which is higher than the front wheel 810 and outside the head tube 111 of the frame 100. The portions of the housing 700 creating the left wing structures 720 are better shown in FIGS. 21-24. The wing structures 720 can generate downward pressure due to wind resistance, thereby increasing the downward force on the front wheel 810 and increasing front wheel traction and road grip during high-speed running of the motorcycle 10. The width W2 of each wing structure 720 extending laterally outward is preferably in the range from 50 mm to 90 mm, more preferably in the range from 60 mm to 80 mm, and most preferably in the range from 60 mm to 70 mm. The length of each wing structure 720 is in the same order of magnitude as its width, such as within a range from one to three times its width.

The housing 700 includes a front cover body 730 covering the front of the motorcycle 10. The wing structures 720 are connected to extend laterally outward from sides of the front cover body 730 of the housing 700. To make this connection sufficiently strong, the wing structures 720 preferably hook to the front cover body 730 and also are further fixedly connected to the front cover body 730 and/or other portions of the housing 700 and/or the frame 100 by using clips and/or screws.

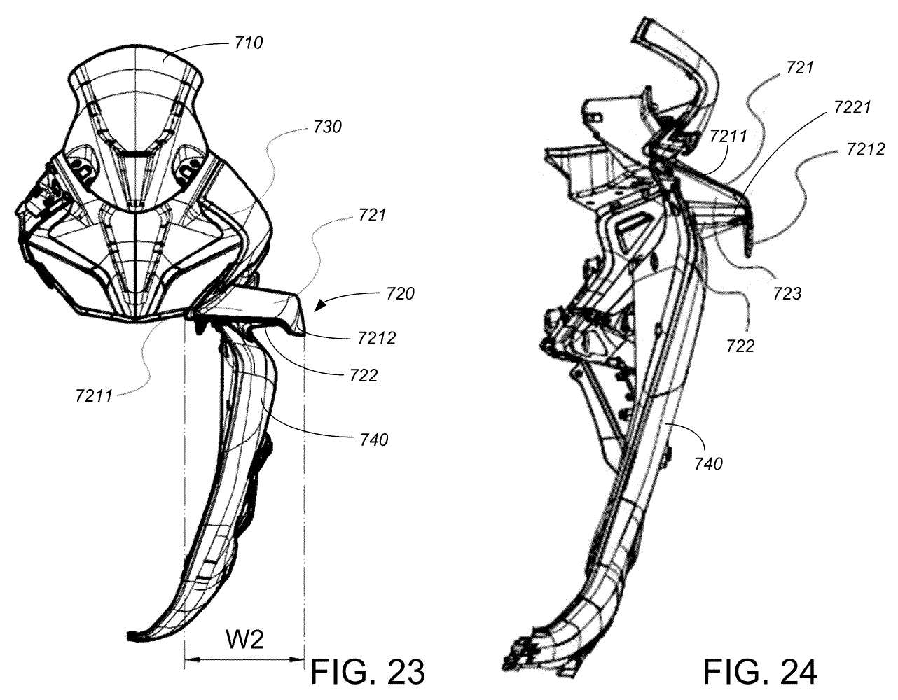

Each of the left and right wing structures 720 includes a leading wing 721 and a trailing wing 722 downstream from the leading wing 721 in the windflow past the motorcycle 10. The trailing wing 722 is also preferably slightly lower than the leading wing 721. The leading wing 721 and the trailing wing 722 are connected to each other at their distal ends, such that the leading wing 721 and the trailing wing 722 define and encircle an air flow gap 723 through the wing structure 720. The air flow gap 723 is hidden from view by the leading wing 721 in the straight on front view of FIG. 23, but can be seen when shown at the angled view of FIG. 24.

The leading wing 721 is preferably a relatively thin structure defining a windward surface 7211 on its top side. The windward surface 7211 extends upwardly and rearwardly, generating downforce by utilizing the wind resistance during high-speed driving of the motorcycle 10. For instance, the windward surface 7211 can extend at an average angle α to horizontal with a value in the range from 15 degrees to 25 degrees. If the length of the windward surface 7211 is too large, the wing structures 720 may cause excessive wind resistance and could lead to loosening of the connection between the wing structures 720 and the front body cover 730 of the housing 700, or could even lead to damage to the wing structures 720. At the same time, wing structures 720 that are too large will excessively increase the weight of the wing structures 720, thereby unbeneficially increasing the weight of the motorcycle 10. If the area of the windward surface 7211 is too small, the downforce generated by the wing structure 720 on the front of the vehicle 10 will be too small. To ensure generation of sufficient downforce, the windward surface 7211 is a curved surface that is inwardly concave, sunken backwards and downwards, thereby increasing the downforce generated.

The leading wing 721 further includes a downwardly extending edge portion 7212 on the outside of the windward portion 7211. The downwardly extending edge portion 7212 connects to the trailing wing 722. Because of this connection, the trailing wing 722 can transfer some of the downforce generated by the leading wing 721 to the housing 700, thereby ensuring the strength of the leading wing 721.

The trailing wing 722 includes a secondary windward surface 7221, receiving air through the air flow gap 723. When the motorcycle 10 is running at a high speed, both the windward surface 7211 of the leading wing 721 and the secondary windward surface 7221 of the trailing wing 722 generate downforce.

The trailing wing 722 is preferably considerably thicker than the leading wing 721, with the preferred trailing wing 722 having a thickness H1 in the range from 18 mm to 27 mm. The thicker trailing wing 722 helps to better support and transfer the downforce to the rest of the housing 700 motorcycle 10, while still not creating too much drag.

When traveling at 160 km/h, the ratio of the downforce generated by the preferred wing structures 720 to the horizontal drag force of the wing structures 720 is in the range from 1.8 to 2.4. The downforce performance of the wing structures 720 is optimized when the ratio of downforce to horizontal drag is as high as possible, for the lowest possible additional weight.

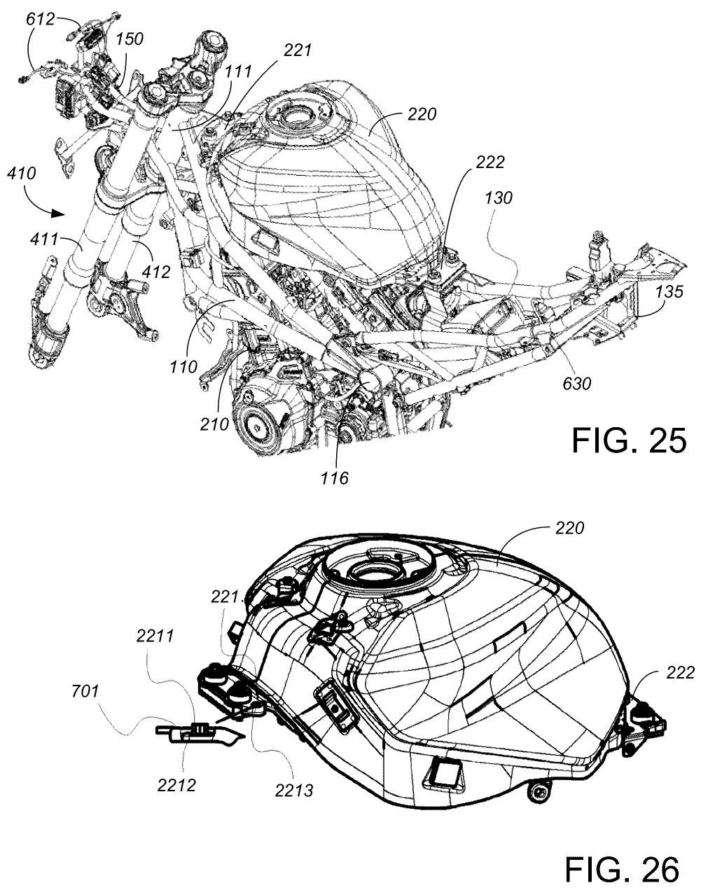

FIGS. 1, 2, 25, 26 and 35 show how the preferred fuel tank 220 is attached to the vehicle 10. The housing 700 further includes a front fuel tank fixing hole 701, preferably just behind the head tube 111 and adjacent one of the upper frame tubes 112. A fuel tank mount 221 includes a connection sleeve 2211 through a clamping plate portion 2212 and a bolt 2213. The clamping plate portion 2212 is held in place by the bolt 2213 passing through the connection sleeve 2211 and into the front fuel tank fixing hole 701, so as to clamp the fuel tank 220 down on one side of the fuel tank fixing hole 701. By using the fuel tank mount 221, any gap deviation between the fuel tank 220 and the housing 700 can be eliminated, thereby improving the consistency of the installation seam of the fuel tank 220.

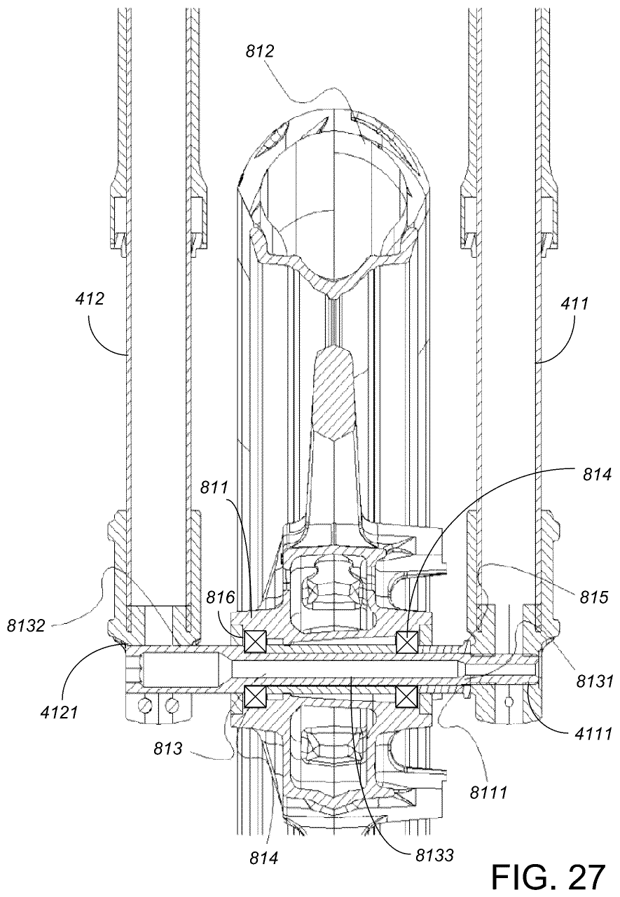

FIG. 27 is a cross-sectional view showing how the front wheel 810 is attached to the vehicle. The front wheel 810 includes a wheel body 811 and a tire 812. An axle hole 8111 is defined centered in the wheel body 811. A wheel axle 813 passes through the axle hole 8111, supporting the front wheel 810 using bearings 814. The wheel axle 813 has a first, narrower connection end 8131 and a second, wider connection end 8132, preferably in a stepped configuration including a middle support section 8133 having an intermediate diameter. The narrower end 8131 of the wheel axle 813 is received in a lower support hole 4111 of a first front shock absorber 411. The wider end 8132 of the wheel axle 813 is received in a lower support hole 4121 of a second front shock absorber 412.

An axle sleeve 815 is arranged in the axle hole 8111 of the wheel body 811, sleeved around the outside of the middle support section 8133 of the wheel axle 813. An oil seal 816 is mounted on the outer side of each of the bearings 814.

The wider connection end 8132 forms a clamping portion. During assembly, the narrower connection end 8131 is inserted through the lower support hole 4121, through one of the bearings 814 and its oil seal 816, through the axle sleeve 815, through the other one of the bearings 814 its oil seal 816, and into the lower support hole 4111, the final step of which simultaneously places the wider connection end 8132 into the lower support hole 4121 for clamping. The bearings 814 and the oil seals 816 are thus sleeved onto the wheel axle 813, so that the bearings 814 and the oil seals 816 are mounted in the axle hole 8111 of the wheel body 811.

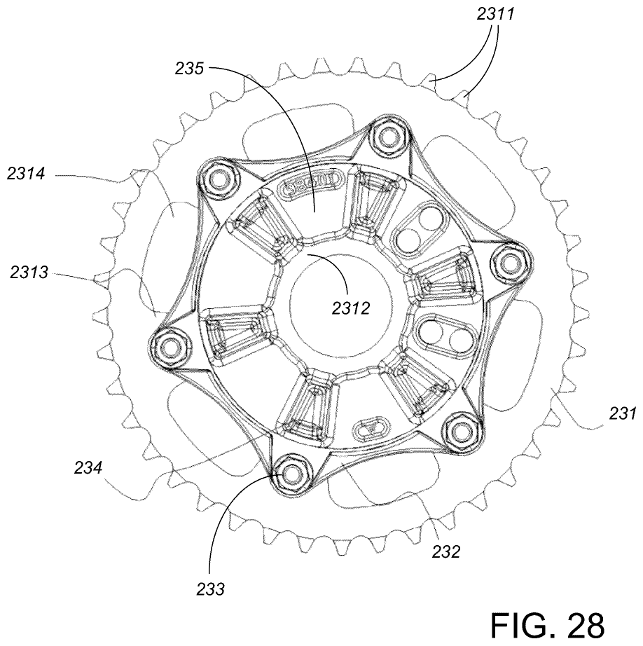

The transmission 230 includes a chain wheel or sprocket 231 shown in FIGS. 1, 2 and 28. A transmission belt or chain (not shown) is driven by the power source 210 and connected to drive the sprocket 231 to rotate. The sprocket 231 has a plurality (in the preferred embodiment, forty-one) of teeth 2311 on its periphery and a hub section 2312 toward its middle. The sprocket 231 has a plurality (in the preferred embodiment, six) of openings defining a plurality (in the preferred embodiment, six) of sprocket spoke sections 2313 therebetween. A sprocket seat 232 is connected to the sprocket 231 by a series of bolts 233 extending through the sprocket spokes 2313. The sprocket seat 232 supports a rubber buffer body 234, which transfers torque from the sprocket seat 232 to a wheel disc 235. The rubber buffer body 234 preferably includes a series of protrusions each defined by a plurality of prisms. An inward portion of the rubber buffer body 234 is recessed, reducing the weight of the transmission 230. A circular mud guide groove (not shown) for guiding the discharge of water, mud and dirt is defined on a side of the wheel disc 235, to reduce the amount of mud and dirt which comes into contact with and gets stuck on the rubber buffer body 234.

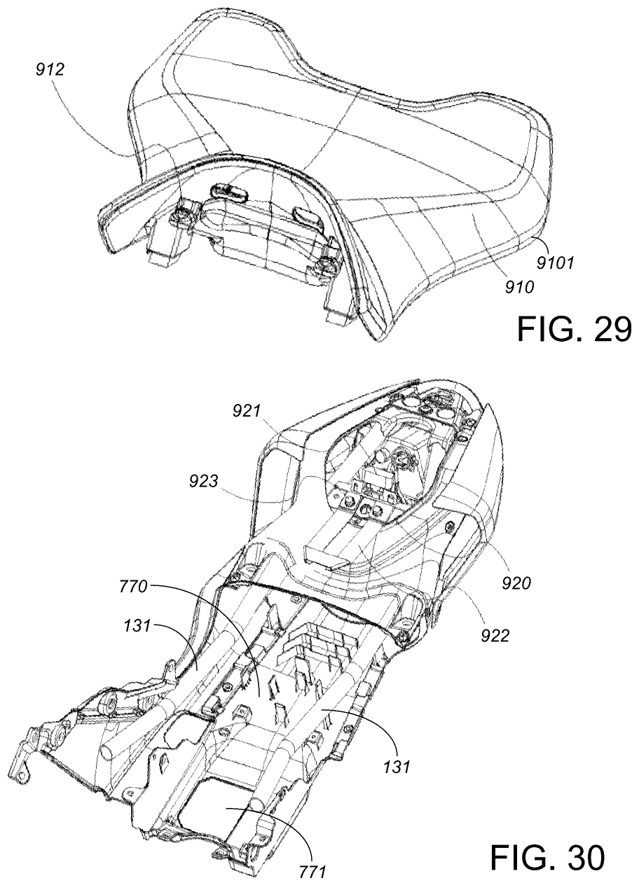

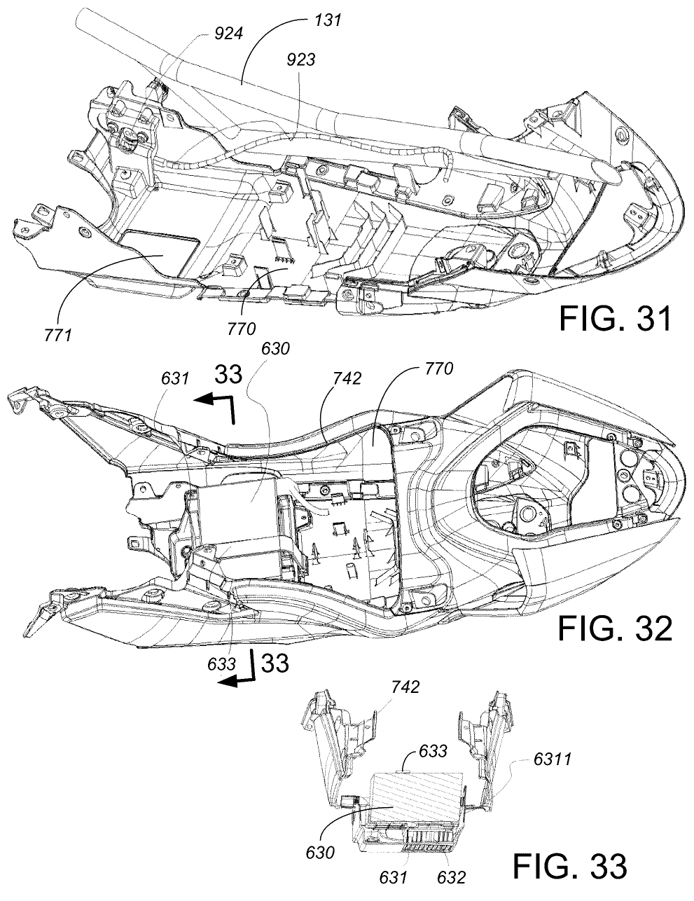

As discussed above with reference to FIGS. 1 and 2, the seating structure 900 includes a main seat cushion 910 for the driver and an upper cushion 930 which can be used by a passenger. Both cushions 910, 930 are connected above the sub-frame 130 such that the seating structure 900 is supported by the frame 100. The seating structure 900 and its attachment to the motorcycle 10 is further explained with reference to FIGS. 29-35. The seating structure 900 preferably includes a seat cushion lock 920 for locking at least one and more preferably both of the seat cushions 910, 930 to the frame 100. The seat cushion lock 920 includes a seat cushion lock fastener 921, a pull strap 922, an underseat lock linkage 923 and one or more underseat latches 924. The seat cushion lock fastener 921 attaches the seat cushion lock 920 to the frame 100. The seat cushion lock fastener 921 is arranged in a mounting space defined between one of the seat cushions 910, 930 and the frame 100, preferably beneath the upper cushion 930. In engaged position(s), the underseat latch(es) 924 hold at least one and more preferably both seat cushions 910, 930 down against the frame 100. At least a portion of the pull strap 922 is exposed outside the mounting space and beyond the seat cushions 910, 930, such as being exposed between the seat cushions 910, 930. The pull strap 920 is formed of strong fabric material which is still flexible and thin enough to not interfere with or cause discomfort for the driver and any passenger seated on the cushions 910, 930. While no one is seated on the motorcycle 10, a user can grip and pull the pull strap 922 to cause the underseat lock linkage 923 to move the underseat latch(es) 924 out of the engaged position(s), thereby releasing the one or both seat cushions 910, 930 so the user can lift the one or both seat cushions 910, 930 off of the frame 100. For instance as shown in FIG. 31, the underseat lock linkage 923 can be formed from a cable which is moved when the pull strap 922 is pulled. The pull strap 922 provides a low cost, lightweight handle for the underseat lock linkage 923, while helping to prevent deformation of the underseat lock linkage 923 which could otherwise be caused by an excessive and misdirected force on a rigid handle and/or rigid linkage.

FIGS. 32 and 33 also show where a power supply 630 of the electrical system 600 is stored within the housing 700 underneath the main seat cushion 910. The power supply 630 is held using a power supply mount 631, which defines a first position for mounting the power supply 630 and a second position preferably underneath the first position for mounting a voltage regulating rectifier 632. The power supply mount 631 also includes two flanges 6311 for attaching the power supply mount 631 to left and right sides of the housing 700. Thus, the power supply mount 631 can not only support the power supply 630 and the voltage regulating rectifier 632, but can also simultaneously strengthen the housing 700. The sub-frame bottom housing plate 770 of the housing 700 preferably includes a heat dissipation opening 771 that can provide heat dissipation for the power supply 630 and/or voltage regulating rectifier 632. A retaining strap 633 is used for holding the power supply 630 in the power supply mount 631, making removal and reassembly of the power supply 630 quick and easy. The retaining strap 633 may be formed of a flexible elastic material.

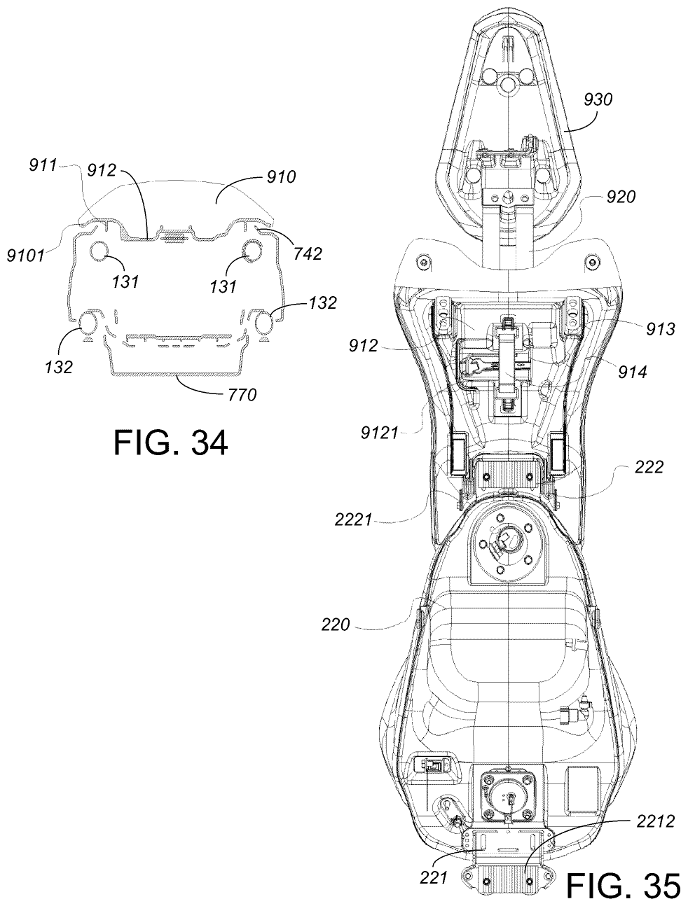

As best shown in FIGS. 32 and 34, the housing 700 includes an underseat lip 742 which extends inwardly beneath the edge 9101 of the main seat cushion 910. The bottom side of the main seat cushion 910 also includes a waterproof rib 911 best shown in FIGS. 34 and 35. The waterproof rib 911 mates with the inner side of the underseat lip 742. The combination of the underseat lip 742 and the waterproof rib 911 cooperatively defines a labyrinth structure that prevents liquids from entering the motorcycle 10 underneath the main seat cushion 910. At the same time, the relationship between the underseat lip 742 and the waterproof rib 911 is not so tight as to affect heat dissipation from the motorcycle 10.

FIG. 35 is a bottom view, looking upwards at the cushions 910, 930 and at the fuel tank 220. The bottom side of the main seat cushion 910 includes a rigid panel 912 which includes a tool slot 9121 for holding a tool such as a wrench 913 using an elastic band 914. The elastic band 914 makes it easy to retrieve and store the tool 913 out of and into its tool slot 9121.

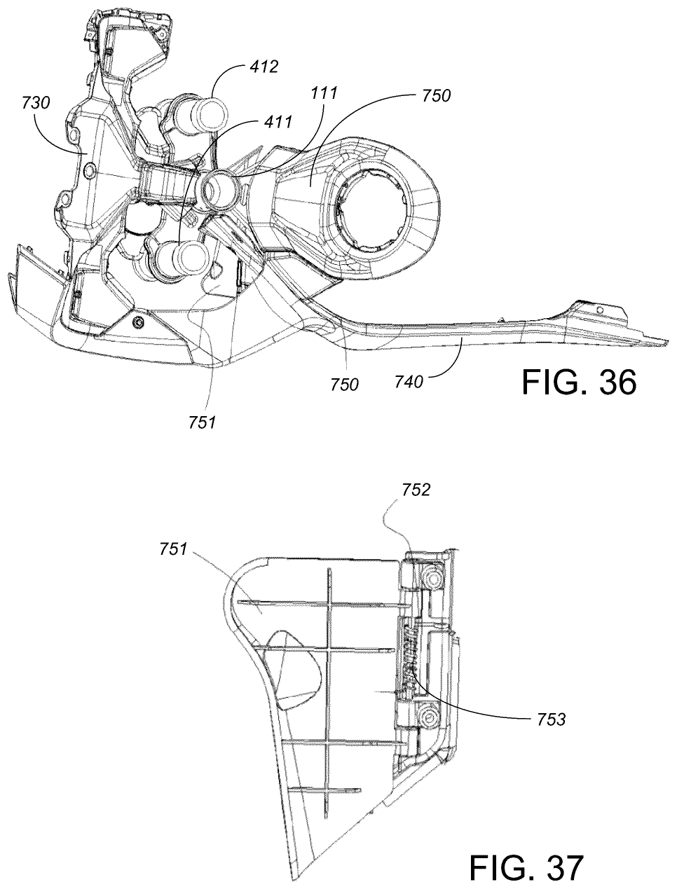

As further shown in FIG. 35, the fuel tank 220 is connected to the frame 100 by a first, front buffer block 2212 and a second, rear buffer block 222. The front buffer block 2212 preferably provides the clamping plate portion of the fuel tank mount 221 shown in FIG. 26. The second buffer block 222 is also used to connect the main seat cushion 910 to the frame 100. A fuel tank positioning member 2221 is connected to the fuel tank 220 and used to attach the fuel tank 220 so that the rear buffer block 222 is arranged between the fuel tank positioning member 2221 and the frame 100. The rear buffer block 222 extends forward to form a tongue structure, the fuel tank positioning member 2221 defines a tongue groove, and the rear buffer block 222 is connected to the tongue groove. The buffer blocks 2212, 222 are formed of a resilient, compressible material such as rubber. The buffering effect of the buffer blocks 2212, 222 on the fuel tank 220 prevents the transmission of excessive vibration from the frame 100 to the fuel tank 220. The buffering effect of the rear buffer block 222 on the main seat cushion 910 enhances comfort of the user riding on the main seat cushion 910. Use of the rear buffer block 222 for attachment of both the fuel tank 220 and the main seat cushion 910 makes the overall structure more compact. FIGS. 1, 2 and 36-40 show various aspects of the housing 700. The housing 700 includes a vehicle cover 750 extending over at least part of the main frame 110, which connects into the front cover body 730 covering the front frame 150. The vehicle cover 750 includes right and left housing flaps 751 best shown in FIGS. 36 and 37. Each housing flap 751 is hingedly mounted on a pivot pin 752 with a torsion spring 753 biasing the housing flap 751 to a forwardly extending covering (generally horizontal) position. Alternatively, the torsion spring 753 could be replaced with a different type of elastic reset element biasing the housing flap 751 to its covering position. When the user drives the motorcycle 10 and makes sharp left or right turns, the front suspension system 410 (such as the right or left front shock absorbers 411, 412) will collide with one of the housing flaps 751. Instead of bending the plastic material of the housing or causing wear, the housing flap 751 will merely pivot out of the way under the force of the front suspension system 410. When the user again turns the steering forward, the torsion spring 753 will pivot the housing flap 751 back to its forwardly extending covering position. By using right and left housing flaps 751, the housing 700 does not interfere with the performance of the front suspension system 410, and the service life of the housing 700 is increased.

As shown in FIGS. 1 and 2, the housing 700 includes a power source side housing 740, which is provided at the side of the power source 210. The power source side housing 740 defines at least one heat dissipation port 741 for dissipating heat from the power source 210 and other components. Optionally, the power source side housing 740 defines two heat dissipation ports 741.

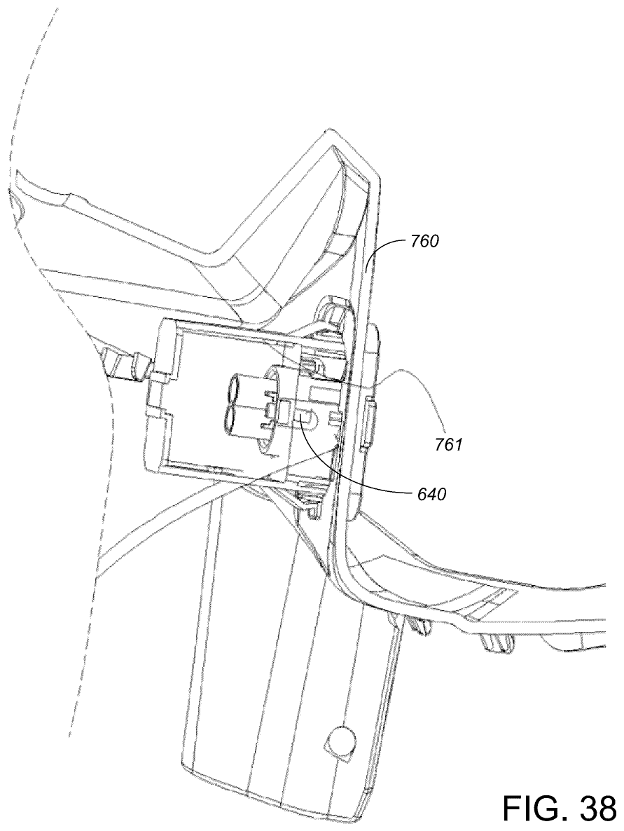

As shown in FIG. 38, at least some portion 760 of the housing 700 supports a universal serial bus (“USB”) interface 640. An elastic sleeve 761 is sleeved with the USB interface 640 and mounts the USB interface 640 to the housing 700 at a desired location, which could be any housing portion 760 convenient for a USB electrical connection to connect to a user accessory. Users can remove the elastic sleeve 761 to quickly disassemble and remove the USB interface 640 from the vehicle 10. Alternatively, the vehicle 10 can be sold with only an elastic sleeve 761 arranged on the housing 700. When a user or dealer later decides to add a USB interface 640 to the vehicle 10, the elastic sleeve 761 can be pulled out of the housing portion 760, a USB interface 640 can be added inside the elastic sleeve 761, and the combined elastic sleeve 761/USB interface 640 can be attached to the housing portion 760. The elastic sleeve 761 thereby reduces costs and facilitates later maintenance and modification.

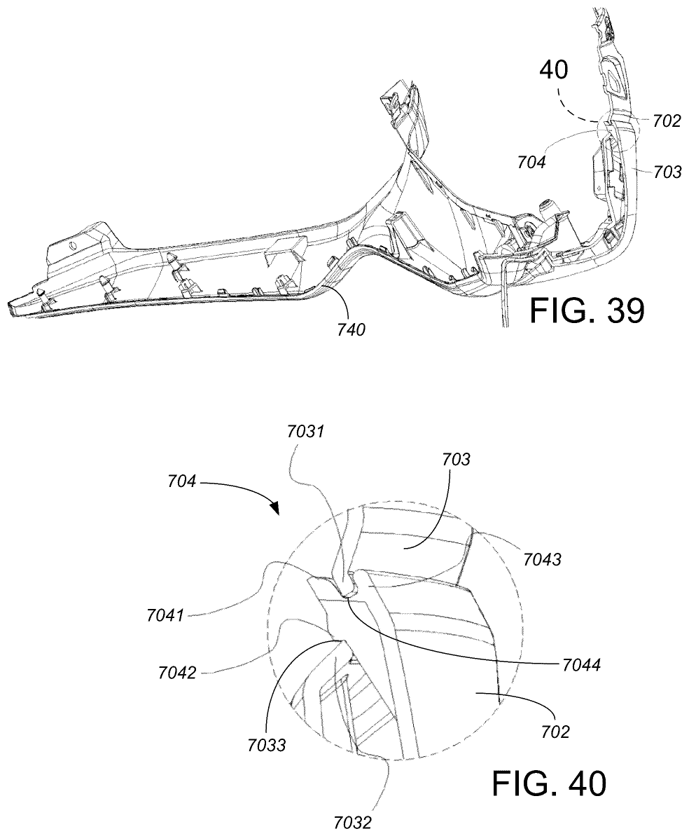

As noted above, the housing 700 includes various separately molded parts, such as front cover body 730, power source side housing 740, vehicle cover 750, housing portion 760 and sub-frame bottom housing plate 770. FIGS. 39 and 40 show an attachment between different housing parts 702, 703, which could be at the seam between any of these separate parts 730, 740, 750, 760, 770 or at any seam within one of these parts 730, 740, 750, 760, 770. At least one first housing part 702 and at least one second housing part 703 are connected to each other by at least one clip 704. The clip 704 includes two barbs 7041, 7042 on one of the housing parts 702. The barbs 7041, 7042 extend outwardly relative to each other but can be inwardly deflected towards each other. The barbs 7041, 7042 are positioned at a hidden location behind a seam lip 7043. A clamping space 7044 is defined between the seam lip 7043 and one of the barbs 7041. The second housing part 703 includes edges 7031, 7032 which cooperatively define an adaptation hole 7033 corresponding in position with the two barbs 7041, 7042. The barbs 7041, 7042 can be inserted into the adaptation hole 7033 with one of the edges 7031 inserted into the clamping space 7044 to hold the two housing parts 702, 703 together. The design of the clip 704 allows for quick assembly of the housing parts 702, 703 together, while providing a strong and relatively weatherproof attachment, and while still allowing for disassembly.

The above-mentioned embodiments only represent several embodiments of the present invention, and the descriptions thereof are relatively specific and detailed, but should not be construed as a limitation to the scope. It should be noted that for those skilled in the art, without departing from the concept of the present invention, several modifications and improvements may be made, which all belong to the scope of the present invention.

1. A motorcycle comprising:
a power system comprising a power source for locomotion of the motorcycle;
a frame supporting the power system;
a manipulation system supported by the frame;
a seating structure arranged above the frame;
a suspension connecting front and rear wheels to the frame;
wherein the frame comprises a main frame comprising:
a head tube;
a plurality of frame tubes connected to the head tube and extending rearwardly therefrom, the plurality of frame tubes comprising at least one upper main frame tube and at least one lower main frame tube;
a mounting plate connected between the upper main frame tube and the lower main frame tube, the mounting plate being adapted for positioning and supporting the power source, and
a casting adapted for connecting to the upper main frame tube and to the lower main frame tube, wherein the casting defines an angle of the upper main frame tube relative to the lower main frame tube.

2. The motorcycle of claim 1, wherein the frame further comprises a sub-frame positioned behind the main frame and secured to the main frame, the sub-frame comprising:
at least one right sub-frame tube on a right side of a longitudinal mid-plane of the motorcycle;
at least one left sub-frame tube on a left side of the longitudinal mid-plane of the motorcycle; and
a license plate mount fixed to both the right sub-frame tube and the left sub-frame tube and extending across the longitudinal mid-pane of the motorcycle.

3. The motorcycle of claim 1, wherein the frame further comprises a middle frame fixed at a rear end of the main frame so as to extend downwardly therefrom, wherein the suspension comprises a rear shock absorber and two rear rocker arms, the two rear rocker arms being pivotally attached to the middle frame to pivot and provide suspension motion of the rear shock absorber.

4. The motorcycle of claim 3, wherein the suspension comprises a shock absorber linkage connected between a bottom end of the rear shock absorber and the middle frame, the shock absorber linkage having at least one first link and at least one second link, the first link being pivotally connected to the middle frame and pivotally connected to the second link, the second link being pivotally connected to at least one of the two rear rocker arms and pivotally connected to the bottom end of the rear shock absorber and pivotally connected to the first link.

5. The motorcycle of claim 1, wherein the frame further comprises a front frame connected to the head tube and extending forwardly therefrom, wherein the manipulation system comprises at least one rear-view mirror having a mirror support arm supported by the front frame portion, the motorcycle further comprising a blinker having a lighting portion on the mirror support arm.

6. The motorcycle of claim 5, wherein the front frame comprises an upper T-tube, a lower T-tube and a head tube mount casting, the head tube mount casting being secured to the head tube and defining a position of the upper T-tube and the lower T-tube relative to the main frame.

7. The motorcycle of claim 1, wherein the main frame comprises a fixation sleeve supported under the lower main frame tube, with a screw barrel insert threadingly received in the fixation sleeve, with a mounting pin bolt threadingly received in the screw barrel insert, the mounting pin bolt mating into an opening of the power source to connect the power source to the frame.

8. The motorcycle of claim 7, wherein an axial position of the screw barrel insert in the fixation sleeve is fixed by a lock nut, and wherein a spacer around the mounting pin bolt separates the screw barrel insert from a face of the power source.

9. A motorcycle comprising:
a power system comprising a power source for locomotion of the motorcycle;
a frame supporting the power system;
a manipulation system supported by the frame;
a housing covering at least a portion of the frame;
at least one front wheel and at least one rear wheel;
wherein the frame comprises:
a main frame comprising:
a head tube;
a plurality of frame tubes connected to the head tube and extending rearwardly therefrom, the plurality of frame tubes comprising at least one upper main frame tube and at least one lower main frame tube; and
a mounting plate connected between the upper main frame tube and the lower main frame tube, the mounting plate being adapted for positioning and supporting the power source, and
a sub-frame positioned behind the main frame and secured to the main frame, the sub-frame comprising:
at least one right sub-frame tube on a right side of a longitudinal mid-plane of the motorcycle;
at least one left sub-frame tube on a left side of the longitudinal mid-plane of the motorcycle; and
a license plate mount fixed to both the right sub-frame tube and the left sub-frame tube and extending across the longitudinal mid-pane of the motorcycle; and
a seating structure comprising a seat cushion for a user to straddle and ride on, the seating structure supported by the sub-frame.

10. The motorcycle of claim 9, wherein the license plate mount comprises a left plate portion angled downwardly and inwardly from the left sub-frame tube, a right plate portion angled downwardly and inwardly from the right sub-frame tube, and a central plate portion extending transversely across the longitudinal mid-plane of the motorcycle, the central plate portion connecting the left plate portion to the right plate portion.

11. The motorcycle of claim 10, wherein the license plate mount defines at least one lightening hole, and wherein the license plate mount comprises at least one reinforcement rib.

12. The motorcycle of claim 8, wherein the housing comprises a leading wing and a trailing wing each extending outwardly from a side of the motorcycle, the leading wing and the trailing wing each being able to generate downward pressure due to wind resistance, thereby increasing the downward force on the front wheel and increasing front wheel traction and road grip during high-speed running of the motorcycle.

13. The motorcycle of claim 12, wherein a distal edge of the leading wing connects to the trailing wing, with an air flow gap defined between the leading wing and the trailing wing.

14. The motorcycle of claim 12, wherein an airflow flow outlet is defined between the leading wing, the trailing wing and the housing.

15. The motorcycle of claim 12, wherein the leading wing has a windward surface with a length in the range from 50 mm to 90 mm, with the windward surface having an angle relative to horizontal in the range from 15 degrees to 25 degrees.

16. A motorcycle comprising:
a power system comprising a power source for locomotion of the motorcycle;
a frame supporting the power system;
a manipulation system supported by the frame, the manipulation system comprising a rear-view mirror on a mirror support arm, the rear view mirror having a reflective surface;
an electrical system support by the frame, the electrical system comprising a turn signal blinker supported on the mirror support arm, wherein the reflective surface of the rear-view mirror can be pivoted relative to the mirror support arm without moving the turn signal blinker relative to the mirror support arm;
a housing covering at least a portion of the frame;
wherein the frame comprises:
a main frame comprising:
ahead tube;
a plurality of frame tubes connected to the head tube and extending rearwardly therefrom, the plurality of frame tubes comprising at least one upper main frame tube and at least one lower main frame tube; and
a mounting plate connected between the upper main frame tube and the lower main frame tube, the mounting plate being adapted for positioning and supporting the power source, and
a sub-frame positioned behind the main frame and secured to the main frame; and
a seating structure comprising a seat cushion for a user to straddle and ride on, the seating structure supported by the sub-frame.

17. The motorcycle of claim 16, wherein the manipulation system further comprises a mirror support seat secured relative to the frame, with the mirror support arm being rotatably connected to the mirror support seat.

18. The motorcycle of claim 17, wherein the mirror support seat and the mirror support arm comprise at least one positioning projection received in a positioning recess, biased together by a spring.

19. The motorcycle of claim 16, wherein a ball pin rod is secured at a distal end of the mirror support arm, and wherein the reflective surface of the rear-view mirror is within a rear-view mirror housing supported on a spherical portion of the ball pin rod.

20. The motorcycle of claim 19, wherein a connection between the ball pin rod and the rear-view mirror allows the reflective surface of the rear-view mirror to pivot at least 200 relative to the mirror support arm.
